(19) United States
(12) Patent Application Publication
(10) Pub. No.: US 2013/0180928 A1
(43) Pub. Date: Jul. 18, 2013

(54) Personal Water Conservation System

(71) Applicant: Marcos VIELMA, San Jose, CA (US)

(72) Inventor: Marcos VIELMA, San Jose, CA (US)

(21) Appl. No.: 13/742,180

(22) Filed: Jan. 15, 2013

Related U.S. Application Data
(60) Provisional application No. 61/587,770, filed on Jan. 18, 2012.

(51) Int. Cl. C02F 1/00

(52) U.S. Cl. CPC C02F 1/008
USPC 210/739; 210/96.1

(57) ABSTRACT

A personal water conservation system includes gray water discharge lines, a main sewage line, an impurity measuring unit, a buffer tank, a directional control valve, a water treatment unit, a treated water tank, an automatic shutoff valve, and at least one toilet flush tank. The buffer tank and the water treatment unit purify the gray water in two different stages. The purified gray water is then stored in the treated water tank. If the gray water can't be purified within the personal water conservation system, the impurity measuring unit and the directional control valve redirect the gray water into the main sewage line. The purified water from the treated water tank can be used with the at least one toilet flush tank in order to conserve fresh water.

The current application claims a priority to the U.S. Provisional Patent application Ser. No. 61/587,770 filed on Jan. 18, 2012.

### FIELD OF THE INVENTION

The present invention relates generally to a system and a method for a water conservation system. More specifically, the water conservation system may be retrofitted to an existing plumbing system or new construction and be installed or contained within the walls of a house, commercial buildings, or stadiums.

### BACKGROUND OF THE INVENTION

A typical bathroom in a standard home comprises at least one sink, shower, and toilet. All three sanitation facilities use fresh water. This wastes a large amount of fresh water, especially in the case of the toilet. Water from the toilet never comes into contact with a user, so it is acceptable to use “gray” water, or recycled water that meets a given cleanliness criteria. Unfortunately, current building codes for new construction and existing home plumbing systems require the use of fresh water in the toilet.

It is therefore an object of the present invention to provide a water conservation system that allows gray water from the sink and shower to be purified, stored, and reused in the house or building for toilet and exterior uses or disaster emergencies. It is a further object of the present invention to provide a water conservation system that can be easily retrofitted to the existing plumbing system and that fits into any walls within the house or building space within the house.

### BRIEF DESCRIPTION OF THE DRAWINGS

FIG. 1 is a perspective view of the present invention, wherein the present invention is utilized within a bathroom layout.

FIG. 2 is a front view of a buffer tank and the impurity measuring unit, showing the plane upon which a cross sectional view is taken shown in FIG. 3.

FIG. 3 is a cross section view of the present invention taken along line A-A of FIG. 2, showing a filter.

FIG. 4 is a perspective view of a water treatment unit and a directional control valve.

FIG. 5 is a side view of the water treatment unit, showing the plane upon which a cross sectional view is taken shown in FIG. 6.

FIG. 6 is a cross section view of the present invention taken along line A-A of FIG. 5, showing a heating element.

FIG. 7 is a side view of a treated water tank, showing the plane upon which a cross sectional view is taken shown in FIG. 8.

FIG. 8 is a cross section view of the present invention taken along line A-A of FIG. 7, showing a circulation pump.

FIG. 9 is a flow chart illustrating the electrical connection of the present invention.

FIG. 10 is a basic flow chart illustrating overall method of cleaning raw gray water into purified gray water.

FIG. 11 is a flow chart illustrating the closing of the control valve within the overall method cleaning raw gray water into purified gray water.

FIG. 12 is a flow chart illustrating the closing of the directional control valve within the overall method cleaning raw gray water into purified gray water.

FIG. 13 is a flow chart illustrating the storing of the purified gray water within the overall method cleaning raw gray water into purified gray water.

FIG. 14 is a flow chart illustrating the flowing of fresh water within the overall method cleaning raw gray water into purified gray water.

### DETAIL DESCRIPTIONS OF THE INVENTION

All illustrations of the drawings are for the purpose of describing selected versions of the present invention and are not intended to limit the scope of the present invention.

The present invention is a system and method for implementing a water diversion system for residential and commercial use to reduce usage of potable water by 50%. The present invention provides a personal water conservation system for raw gray water where the filtered water from the personal water conservation system is used within other areas with priority over fresh water, including but not limited to toilet, garden sprinklers. The personal water conservation system of the present invention is designed to be built into or retrofitted to any living accommodation structure, including but not limited to single detached houses, apartment buildings, development estates, hotels, and other residential or commercial buildings.

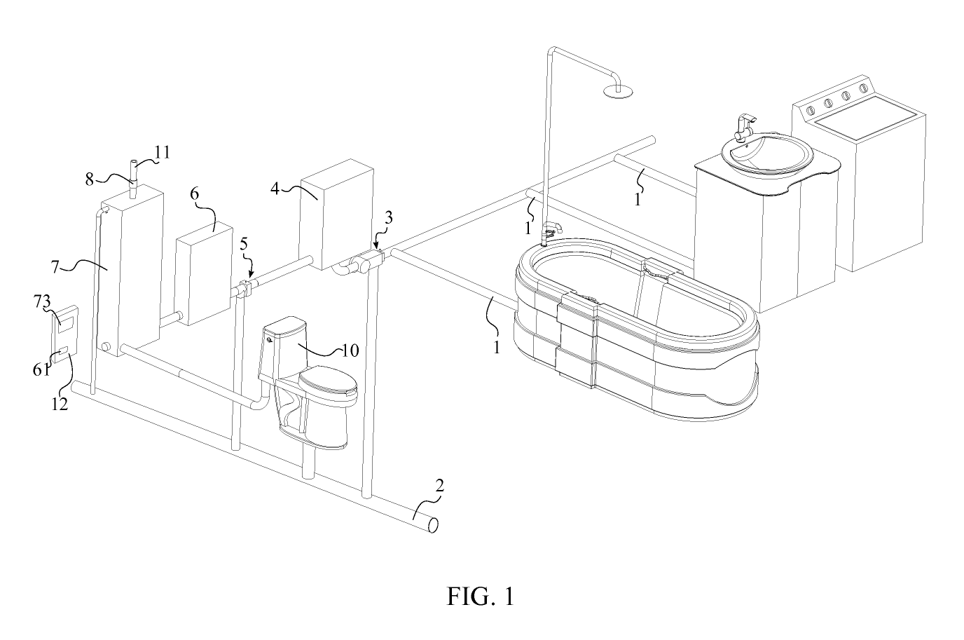

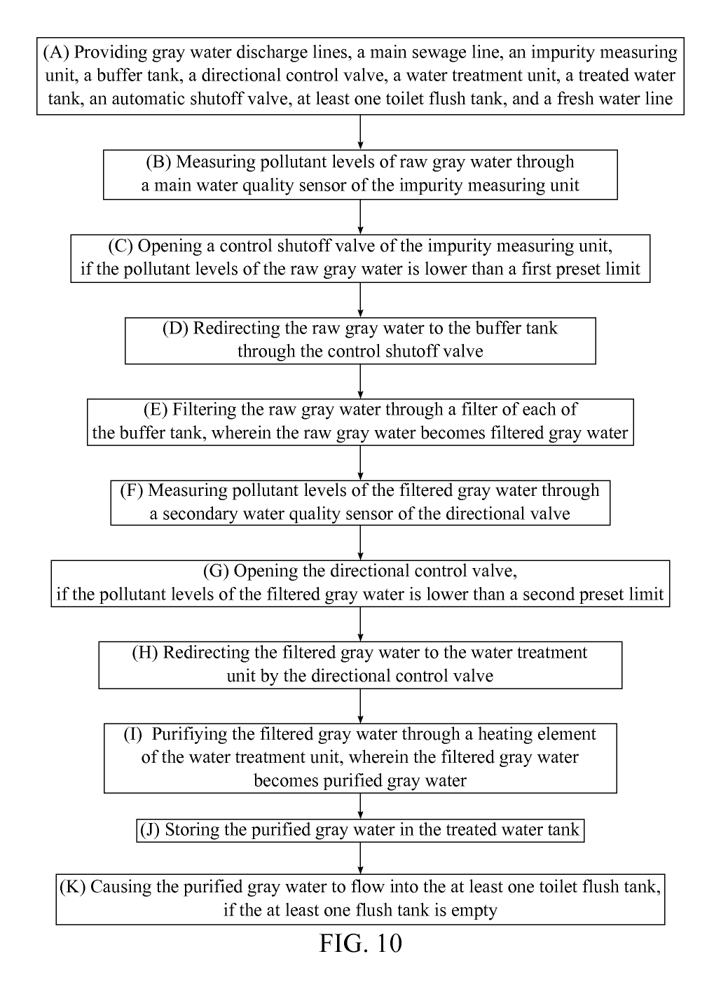

In reference to FIG. 1 and FIG. 10, the personal water conservation system comprises gray water discharge lines 1, a main sewage line 2, an impurity measuring unit 3, a buffer tank 4, a directional control valve 5, a water treatment unit 6, a treated water tank 7, an automatic shutoff valve 8, at least one toilet flush tank 10, a fresh water line 11, and a control panel 12. The gray water discharge lines 1 in the personal water conservation system include, but are not limited to a bath shower discharge line, a washing basin discharge line, a laundry machine discharge line, a dishwasher discharge line, and other related discharge lines. In the traditional residential and commercial building layouts, the gray water discharge lines 1 are in fluid communication with the main sewage line 2 where the gray water discharge lines 1 release the raw gray water to the main sewage line 2. The main sewage line 2 then redirects the raw gray water to the municipal sewer line.

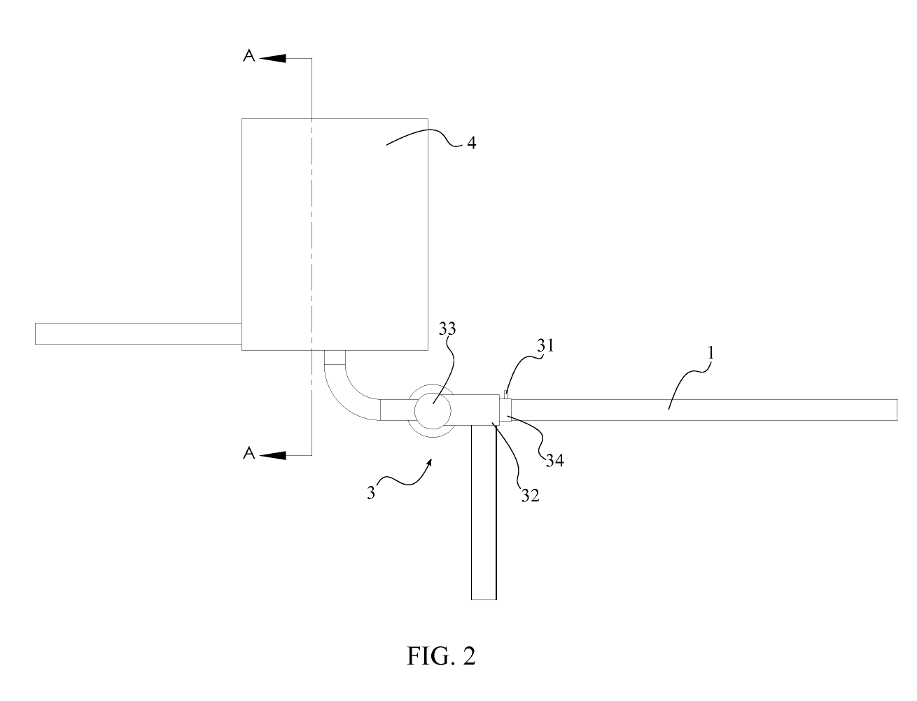

In reference to FIG. 2, the impurity measuring unit 3 comprises a gray water inlet 34, a main water quality sensor 31, control shutoff valve 32, and a pump 33. The impurity measuring unit 3 is positioned in between the gray water discharge lines 1 and the main sewage line 2. The impurity measuring unit 3 is in fluid communication with the gray water discharge lines 1 through the gray water inlet 34 and with the main sewage line 2. The main water quality sensor 31 is traversed into the gray water inlet 34, and the pump 33 is positioned within the impurity measuring unit 3 opposite from the main water quality sensor 31. The control shutoff valve 32 is positioned within the impurity measuring unit 3 in between the main water quality sensor 31 and the pump 33. The pump 33 and the main water quality sensor 31 are preferably inconspicuously small so that they can be adjacently positioned within the impurity measuring unit 3. The pump 33 is in fluid communication with the control shutoff valve 32, and the gray water inlet 34 is in fluid communication with the control shutoff valve 32. The main water quality sensor 31 senses the pollutant types and levels of the raw gray water being discharged from the gray water discharge lines 1. The main water quality sensor 31 is programmed with a first preset limit, where the first present limit is the maximum allowable pollutant types and levels through the impurity measuring unit 3. The control shutoff valve 32 controls the flow direction of the raw gray water where the control shutoff valve 32 is communicatively coupled with the main water quality sensor 31. The control shutoff valve 32 can be a mechanically, electrically, or hydraulically operated module, where the selection process of the correct module depends on the aesthetical and economical factors. The impurity measuring unit 3 is preferably installed behind the drywall and in between the post of the house frame in order to save livable space of the house.

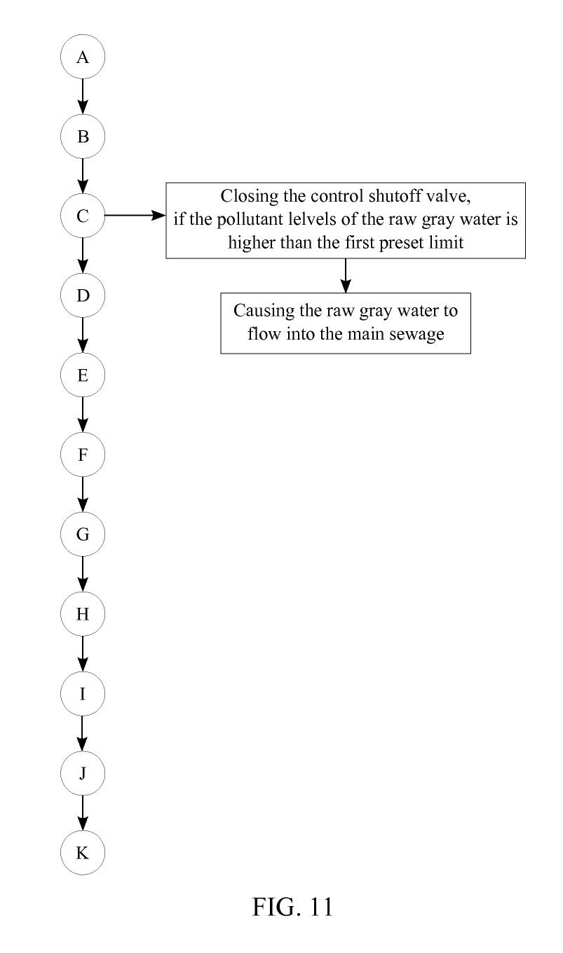

When the raw gray water exits from the gray water discharge lines 1, the main water quality sensor 31 measure the pollutant types and levels of the raw gray water. Since the control shutoff valve 32 is communicatively coupled with the main water quality sensor 31, the output of the main water quality sensor 31 individually operates the control shutoff valve 32. If the pollutant types and levels of the raw gray water are lower than the first present limit, the main quality water sensor simultaneously opens the control shutoff valve 32 and turns on the pump 33 so that the raw gray water can be directed toward the pump 33. In reference to FIG. 11, if the pollutant types and levels of the raw gray water are higher than the first present limit, the main water quality sensor 31 closes the control shutoff valve 32 so that the raw gray water can be directed toward the main sewage line 2.

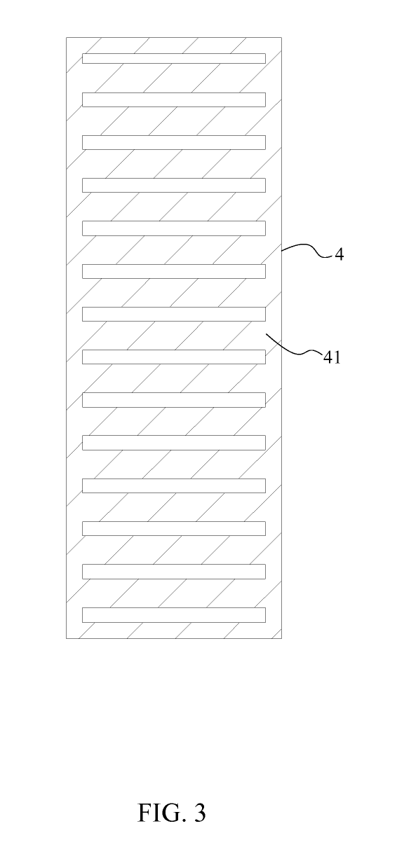

In reference to FIG. 3, the buffer tank 4 comprises a filter 41 where the buffer tank 4 is in fluid communication with the pump 33. The filter 41 is concentrically positioned within the buffer tank 4. The buffer tank 4 can be installed in an attic, or in any available and easy to reach space which is not functional to the house such as the space between posts of the house frame behind the drywalls, or any other desirable location. The buffer tank 4 of the personal water conservation system is preferably installed behind the drywall and in between the posts of the house frame as the shape of the buffer tank 4 maximizes the installation area. When the buffer tank 4 is installed behind the drywall and in between the posts of the house frame, the buffer tank 4 is completely hidden away from the user providing an esthetically clean installation while saving livable space of the house. Once the pump 33 is turned on, the pump 33 transports the raw gray water into the buffer tank 4. Then the raw gray water is filtered through the filter 41 to reduce the pollutant types and levels, where the raw gray water becomes filtered gray water within the personal water conservation system.

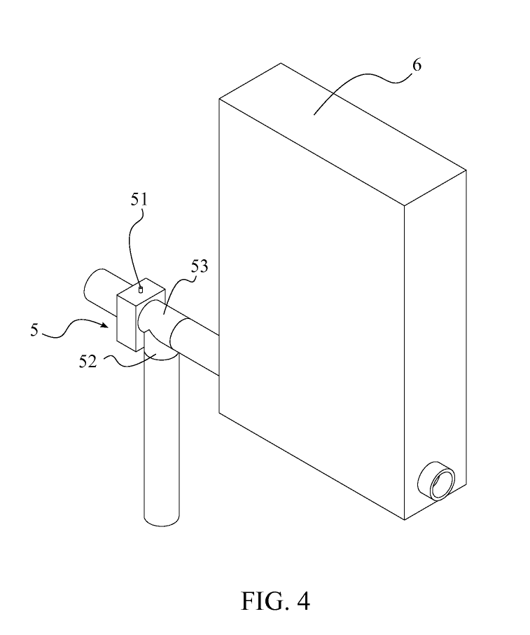

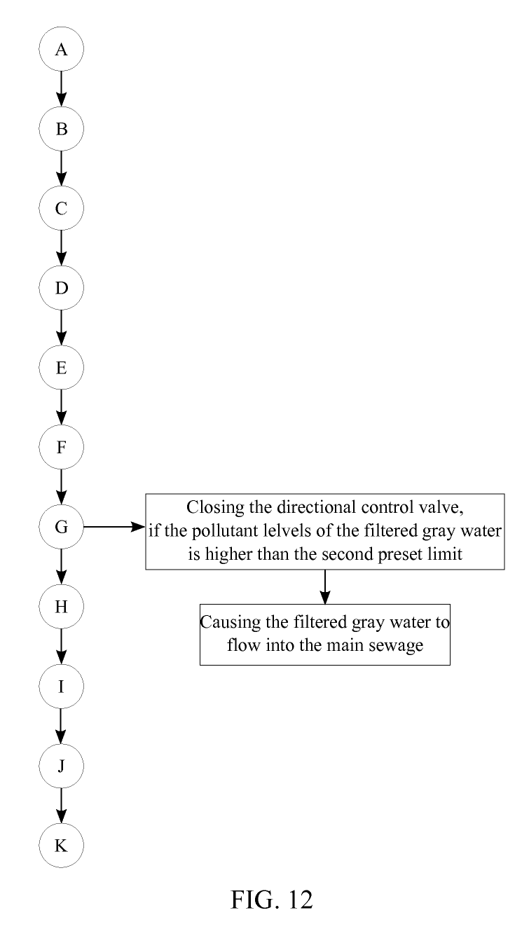

In reference to FIG. 1 and FIG. 4, the directional control valve 5 is positioned in between the buffer tank 4 and the water treatment unit 6 where the directional control valve 5 is in fluid communication with the buffer tank 4, the water treatment unit 6, and the main sewage line 2. The directional control valve 5 comprises a secondary water quality sensor 51, a sewage outlet 52, and a treatment outlet 53. The secondary water quality sensor 51 is positioned within the directional control valve 5 and communicatively coupled with the sewage outlet 52 and the treatment outlet 53. More specifically, the directional control valve 5 is in fluid communication with the main sewage line 2 through the sewage outlet 52 and water treatment unit 6 through the treatment outlet 53. The secondary water quality sensor 51 is programmed with a second preset limit, where the second present limit is the maximum allowable pollutant types and levels through the directional control valve 5. Depending on the output of the secondary water quality sensor 51, the directional control valve 5 either transports into an opened position or a closed position. The functionality of the directional control valve 5 in between the opened position and the closed position can be mechanically, electrically, or hydraulically executed. If the pollutant types and levels of the filtered gray water are lower than the second preset limit, the directional control valve 5 transports into the opened position where the filtered gray water is redirected to the water treatment unit 6 through the treatment outlet 53. In reference to FIG. 12, if the pollutant types and levels of the filtered gray water are higher than the second preset limit, the directional control valve 5 transports into the closed position where the filtered gray water is redirected to the main sewage line 2 through the sewage outlet 52. The directional control valve 5 is preferably installed behind the drywall and in between the post of the house frame in order to save livable space of the house.

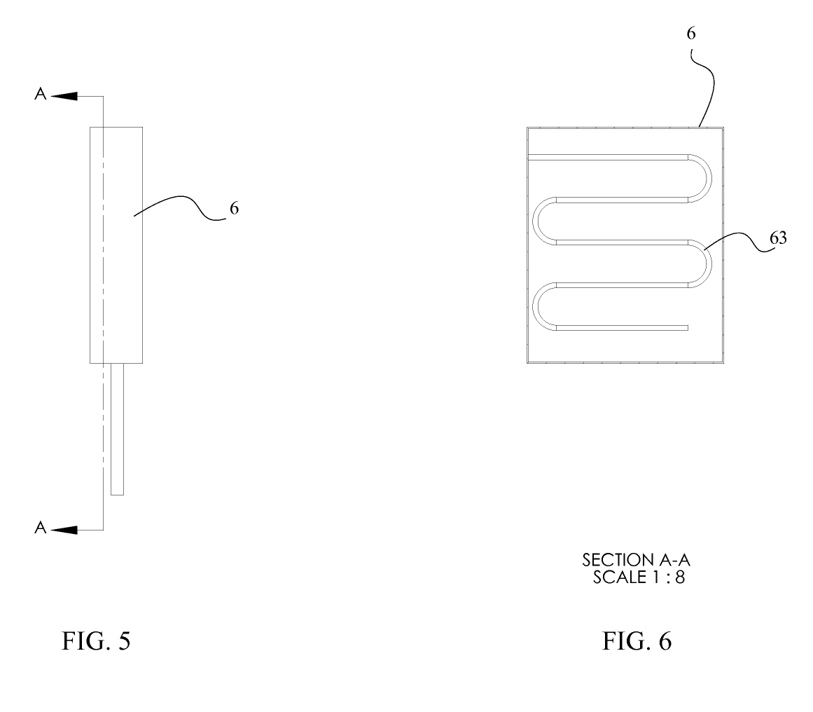

In reference to FIG. 5 and FIG. 6, the water treatment unit 6 comprises a heating element 63. The water treatment unit 6 can be installed in an attic, or in any available and easy to reach space which is not functional to the house such as the space between posts of the house frame behind the drywalls, or any other desirable location. The water treatment unit 6 of the personal water conservation system is preferably installed behind the drywall and in between the posts of the house frame as the shape of the water treatment unit 6 maximizes the installation area. When the water treatment unit 6 is installed behind the drywall and in between the posts of the house frame, the water treatment unit 6 is completely hidden away from the user providing an esthetically clean installation while saving livable space of the house. The heating element 63 is positioned within the water treatment unit 6. Once the filtered gray water enters into the water treatment unit 6, the heating element 63 purifies the filtered gray water as the heating element 63 produces thermal energy. Any harmful bacteria or other undesirable substances in the filtered gray water are removed from the thermal convection of the thermal energy. After the filtered gray water is sterilized from the heating element 63, the filtered gray water becomes purified gray water within the personal water conservation system.

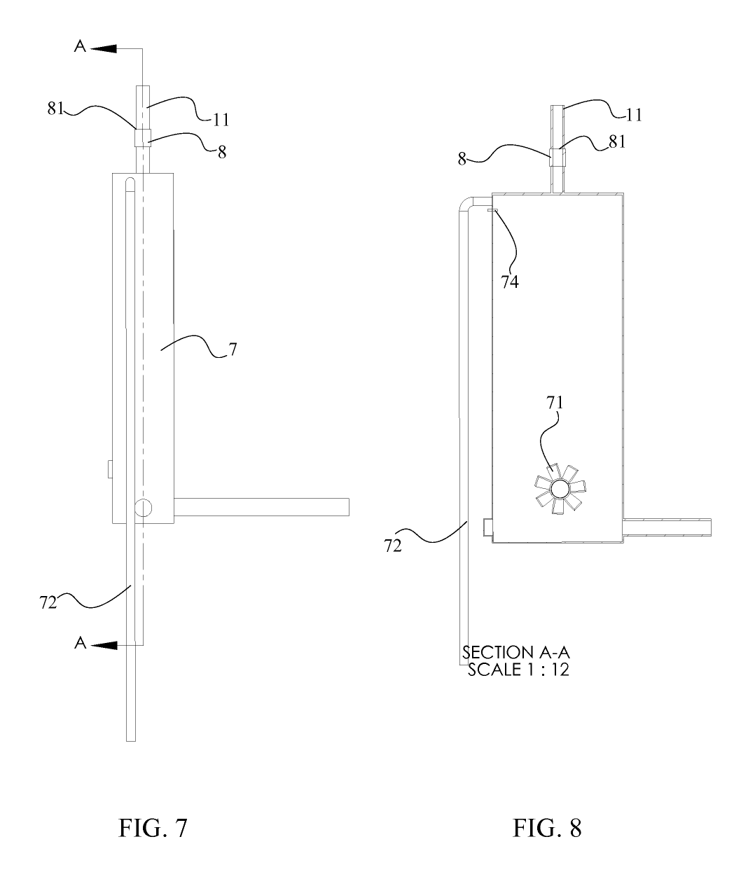

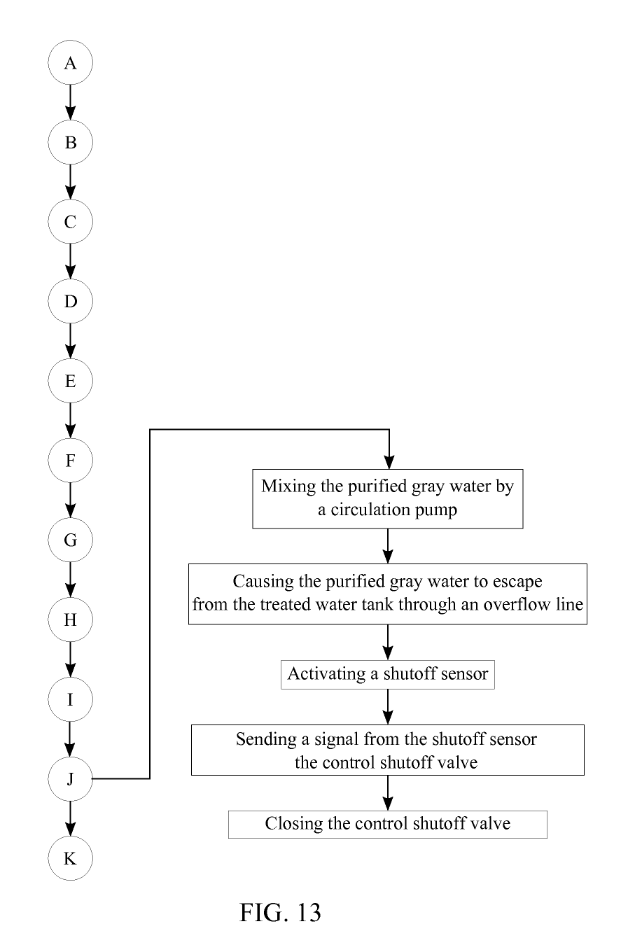

In reference to FIG. 1, FIG. 7, FIG. 8, and FIG. 13, the treated water tank 7 is in fluid communication with the water treatment unit 6, where the treated water tank 7 stores the purified gray water from the water treatment unit 6. The treated water tank 7 can be installed in an attic, or in any available and easy to reach space which is not functional to the house such as the space between posts of the house frame behind the drywalls, or any other desirable location. The treated water tank 7 of the personal water conservation system is preferably installed behind the drywall and in between the posts of the house frame as the shape of the treated water tank 7 maximizes the installation area. When treated water tank 7 is installed behind the drywall and in between the posts of the house frame, treated water tank 7 is completely hidden away from the user providing an esthetically clean installation while saving livable space of the house. The treated water tank 7 comprises a circulation pump 71, an overflow line 72, and a shutoff sensor 74. The circulation pump 71 is positioned within a bottom end of the treated water tank 7, where the circulation pump 71 periodically mixes the purified gray water so that growth of bacteria or other undesirable substances can be prevented within the treated water tank 7. The overflow line 72 is traversed out from a top end of the treated water tank 7, and the overflow line 72 is in fluid communication with the main sewage line 2. The shutoff sensor 74 is positioned within the treated water tank 7 adjacent to the overflow line 72 that is also known as a shutoff point, and the shutoff sensor 74 is communicatively coupled with the control shutoff valve 32. When the treated water tank 7 is filled with the purified gray water and reaches the shutoff point, the shutoff sensor 74 sends a signal to the control shutoff valve 32. The signal then closes the control shutoff valve 32 stopping the additional raw gray water from entering into the buffer tank 4. At the same time, excess purified gray water exits to the main sewage line 2 from the treated water tank 7 through the overflow line 72. Depending on the usage of the water, more than one treated water tank 7 can be added to the personal water conservation system in order to store additional purified gray water.

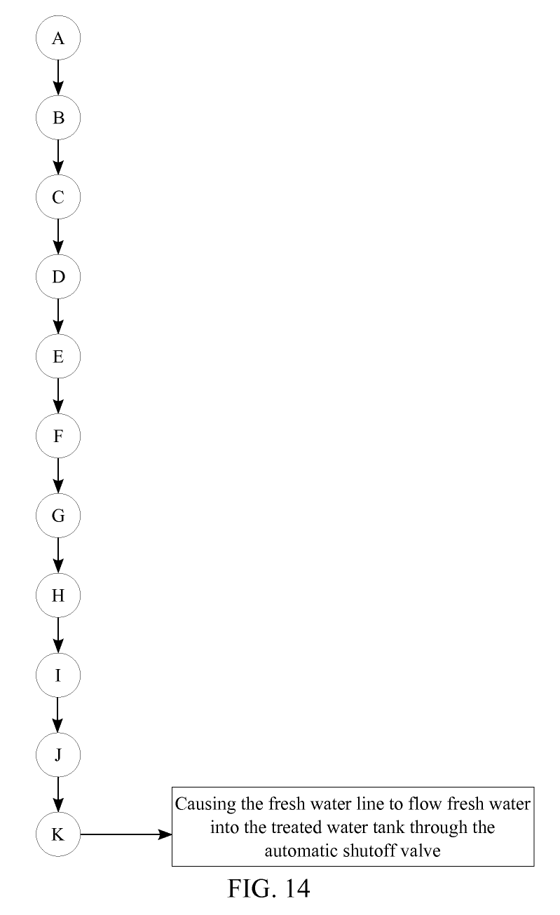

In reference to FIG. 8 and FIG. 14, the automatic shutoff valve 8 is positioned in between the treated water tank 7 and the fresh water line 11 where the automatic shutoff valve 8 comprises a fresh water inlet 81. The fresh water inlet 81 is positioned on the automatic shutoff valve 8. The automatic shutoff valve 8 is in fluid communication with the treated water tank 7 from one extremity, and the fresh water inlet 81 is concentrically connected with the fresh water line 11 from another extremity. The automatic shutoff valve 8 keeps fresh water shut off from the fresh water line 11 unless the treated water tank 7 is empty.

The treated water tank 7 is in fluid communication with the at least one toilet flush tank 10. Whenever the at least one toilet flush tank 10 is emptied by the user, the purified gray water flows into the at least one toilet flush tank 10 from the treated water tank 7, filling the at least one toilet flush tank 10. If the treated water tank 7 does not have enough water to fill the at least one toilet flush tank 10, the automatic shutoff valve 8 senses the limited amount of purified gray water and opens the fresh water line 11 providing fresh water so that the at least one toilet flush tank 10 can be filled with fresh water.

The control panel 12 comprises a thermostat 61, an electrical power supply 62, and a digital panel 73. The control panel 12 is the only visible component of the personal water conservation system as the control panel 12 may be installed on a wall or any other place that is easily accessed by the users. The thermostat 61 and the digital panel 73 are positioned on the control panel 12, and the electrical power supply 62 is connected to the control panel 12. The electrical power supply 62 provides the necessary electrical power from an external power source so that the personal water conservation system can be powered. The thermostat 61 is communicatively coupled with the heating element 63 enabling the users to control the heating element 63 through the thermostat 61. The digital panel 73 allows the user to easily observe and keep track of technical details relating to the performance of the personal water conservation system and the water level in the treated water tank 7 as well as information about the usage of the purified gray water. This allows the users to observe how much water is being saved through the use of the personal water conservation system. The digital panel 73 may comprise a computer screen, an LCD screen, or any other sort of screen and related gauges.

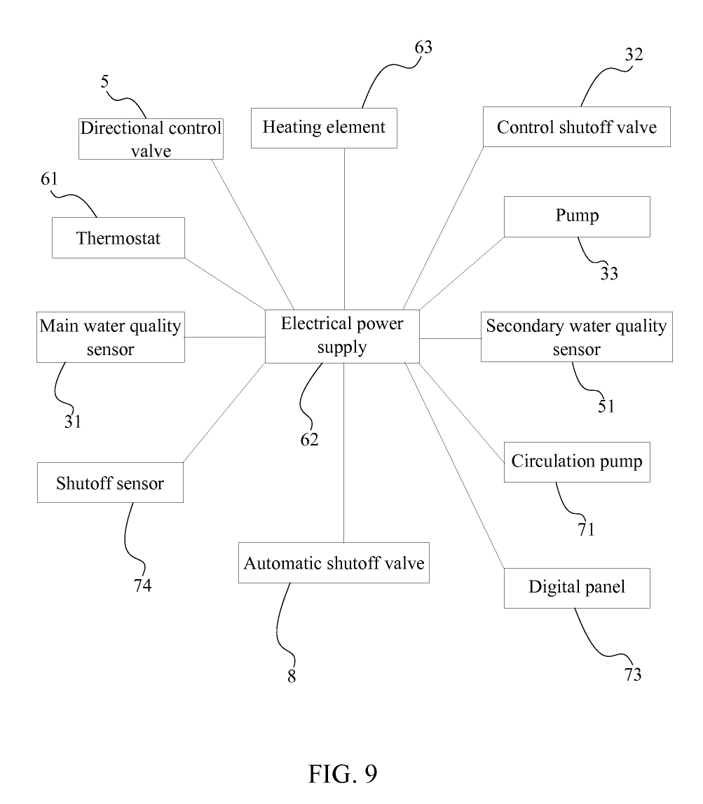

In reference to FIG. 9, the thermostat 61, the heating element 63, the main water quality sensor 31, the control shutoff valve 32, the pump 33, the secondary water quality sensor 51, the directional control valve 5, the circulation pump 71, the digital panel 73, the shutoff sensor 74, and the automatic shutoff valve 8 are electrically connected to the electrical power supply 62 in order for them to properly function within the personal water conservation system.

When the personal water conservation system is retrofitted into the existing plumbing systems, the modification of existing plumbing is limited to the addition of the “T” junctions. The “T” junctions allow the components of the personal water conservation system to be attached with the existing plumbing, although additional modifications may be made if desired.

Each functional module of the personal water conservation system is available in different versions that allow more sophisticated recycling from more polluted waters to more “noble” destination of the treated waters. Obviously, the sophistication of the personal water conservation system increases as the objective of recycling becomes more ambitious. The processing and storing hardware can also serve several additional sanitation facilities.

Although the invention has been explained in relation to its preferred embodiment, it is to be understood that many other possible modifications and variations can be made without departing from the spirit and scope of the invention as hereinafter claimed.

What is claimed is:

1. A system for purifying gray water comprises,
gray water discharge lines;
a main sewage line;
an impurity measuring unit;
a buffer tank;
a directional control valve;
a water treatment unit;
a treated water tank;
an automatic shutoff valve;
at least one toilet flush tank;
a fresh water line;
a control panel;
the impurity measuring unit comprises a gray water inlet, a main water quality sensor, a control shutoff valve, and a pump;
the buffer tank comprises a filter;
the directional control valve comprises a secondary water quality sensor, a sewage outlet, and a treatment outlet;
the water treatment unit comprises a heating element;
the treated water tank comprises a circulation pump, an overflow line, an automatic shutoff valve, and a shutoff sensor; and
the control panel comprises a thermostat, an electrical power supply and a digital panel.

2. The system for purifying gray water as claimed in claim 1 comprises,
the impurity measuring unit being positioned in between the gray water discharge lines and the main sewage line;
the impurity measuring unit is in fluid communication with each of the gray water discharge lines through the gray water inlet;
the main water quality sensor being traversed into the gray water inlet;
the pump being positioned within the impurity measuring unit opposite from the main water quality sensor;
the control shutoff valve being positioned in between the main water quality sensor and the pump;
the control shutoff valve being in fluid communication with both the gray water inlet and the pump;
the control shutoff valve is in fluid communication with the main sewage line; and
the main water quality sensor being communicatively coupled with the control shutoff valve.

3. The system for purifying gray water as claimed in claim 1 comprises,
the buffer tank is in fluid communication with the impurity measuring unit through the pump; and
the filter being concentrically positioned within the buffer tank.

4. The system for purifying gray water as claimed in claim 1 comprises,
the directional control valve is positioned in between the buffer tank and the water treatment unit;
the directional control valve is in fluid communication with the buffer tank;
the secondary water quality sensor being traversed into the directional control valve;
the sewage outlet and the treatment outlet being positioned on the directional control valve opposite from the secondary water quality sensor; and
the sewage outlet and the treatment outlet being communicatively coupled with the secondary water quality sensor.

5. The system for purifying gray water as claimed in claim 1 comprises,
the directional control valve is in fluid communication with the main sewage line through the sewage outlet.

6. The system for purifying gray water as claimed in claim 1 comprises,
the directional control valve is in fluid communication with the water treatment unit through the treatment outlet; and
the heating element being positioned within the water treatment unit.

7. The system for purifying gray water as claimed in claim 1 comprises,
the treated water tank is in fluid communication with the water treatment unit;
the circulation pump being positioned within the treated water tank;
the overflow line being traversed out from the treated water tank;
the treated water tank is in fluid communication with the automatic shutoff valve;
the shutoff sensor being positioned within the treated water tank adjacent to the overflow line; and
the shutoff sensor being communicatively coupled with the control shutoff valve.

8. The system for purifying gray water as claimed in claim 1 comprises,
the automatic shutoff valve comprises a fresh water inlet;
the fresh water inlet being positioned on the automatic shutoff valve; and
the fresh water inlet being in fluid communication with the fresh water line.

9. The system for purifying gray water as claimed in claim 1 comprises,
the treated water tank is in fluid communication with the at least one toilet flush tank.

10. The system for purifying gray water as claimed in claim 1 comprises,
the control panel being adjacently positioned with the treated water tank, wherein the control panel is accessible to a user;
the thermostat and the digital panel being positioned on the control panel;
the thermostat being communicatively coupled with the heating element;
the electrical power supply being connected with the control panel; and
the electrical power supply being electrically connected with the thermostat, the digital panel, the heating element, the main water quality sensor, the control shutoff valve, the pump, the secondary water quality sensor, the directional control valve, the circulation pump, the shutoff sensor, and the automatic shutoff valve.

11. A method of purifying gray water comprises the steps of:
(A) providing gray water discharge lines, a main sewage line, an impurity measuring unit, a buffer tank, a directional control valve, a water treatment unit, a treated water tank, an automatic shutoff valve, at least one toilet flush tank, and a fresh water line, wherein the gray water discharge lines are in fluid communication with the at least one toilet flush tank through the impurity measuring unit, the buffer tank, the directional valve, the water treatment unit, and the treated water tank respectively, and the main sewage line is in fluid communication with the impurity measuring unit and the directional control valve;
(B) measuring pollutant levels of raw gray water through a main water quality sensor of the impurity measuring unit;
(C) opening a control shutoff valve of the impurity measuring unit,
if the pollutant levels of the raw gray water is lower than a first preset limit;
(D) redirecting the raw gray water to the buffer tank through the control shutoff valve;
(E) filtering the raw gray water through a filter of the buffer tank, wherein the raw gray water becomes filtered gray water;
(F) measuring the pollutant levels of the filtered gray water through a secondary water quality sensor of the directional control valve;
(G) opening the directional control valve,
if the pollutant levels of the filtered gray water is lower than a second preset limit;
(H) redirecting the filtered gray water to the water treatment unit by the directional control valve;
(I) purifying the filtered gray water through a heating element of the water treatment unit, wherein the filtered water becomes purified gray water;
(J) storing the purified gray water in the treated water tank; and
(K) causing the purified gray water to flow into the at least one toilet flush tank,
if the at least one toilet flush tank is empty.

12. The method of purifying gray water as claimed in claim 11 comprises the steps of:
closing the control shutoff valve,
if the pollutant levels of the raw gray water is higher than the first preset limit; and
causing the raw gray water to flow into the main sewage line.

13. The method of purifying gray water as claimed in claim 11 comprises the steps of:
closing the directional control valve,
if the pollutant levels of the filtered gray water is higher than the second preset limit; and
causing the filtered gray water to flow into the main sewage line.

14. The method of purifying gray water as claimed in claim 11 comprises the steps of:
mixing the purified gray water periodically by a circulation pump within the treated water tank;
causing the purified gray water to escape from the treated water tank through an overflow line of the treated water tank,
if the purified gray water reaches the overflow line;
activating a shutoff sensor of the treated water tank,
if the purified gray water reaches a shutoff point;
sending a signal from the shutoff sensor to the control shutoff valve; and
closing the control shutoff valve by the signal, wherein the control shutoff valve stops additional raw gray water from entering into the buffer tank.

15. The method of purifying gray water as claimed in claim 11 comprises the steps of:
causing the fresh water line to flow fresh water into the treated water tank through the automatic shutoff valve,
if the treated water tank does not have any of the purified gray water.
